(19) United States
(12) Patent Application Publication
(10) Pub. No.: US 2011/0149572 A1
(43) Pub. Date: Jun. 23, 2011

(54) ROPE LIGHT

(76) Inventor: Ko Yu-chow, Hong Kong SAR (CN)

(21) Appl. No.: 12/852,785

(22) Filed: Aug. 9, 2010

(30) Foreign Application Priority Data
Dec. 22, 2009 (CN) 200920265932.3

(51) Int. Cl. F21S 4/00

(52) U.S. Cl. 362/249.06

(57) ABSTRACT

A rope light including an inner layer having first and second ends; an outer layer, wherein the outer layer covers an outer surface of the inner layer; at least one aperture positioned in the interior of the inner layer; at least one LED light positioned within the aperture; at least one bus connector having at least one of a positive electrode and a negative electrode, wherein the bus connector is placed along the direction of the aperture; and at least one rectifying diode is placed at each positive and negative end of the LED light that is positioned inside the aperture.

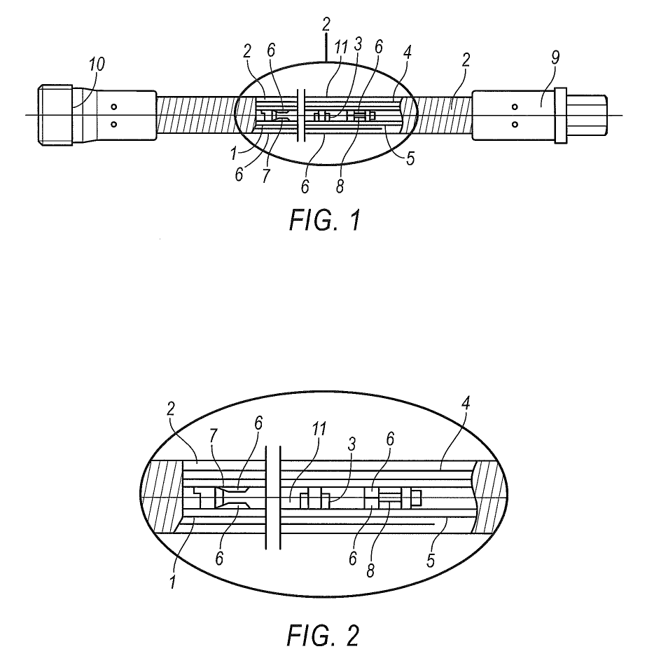

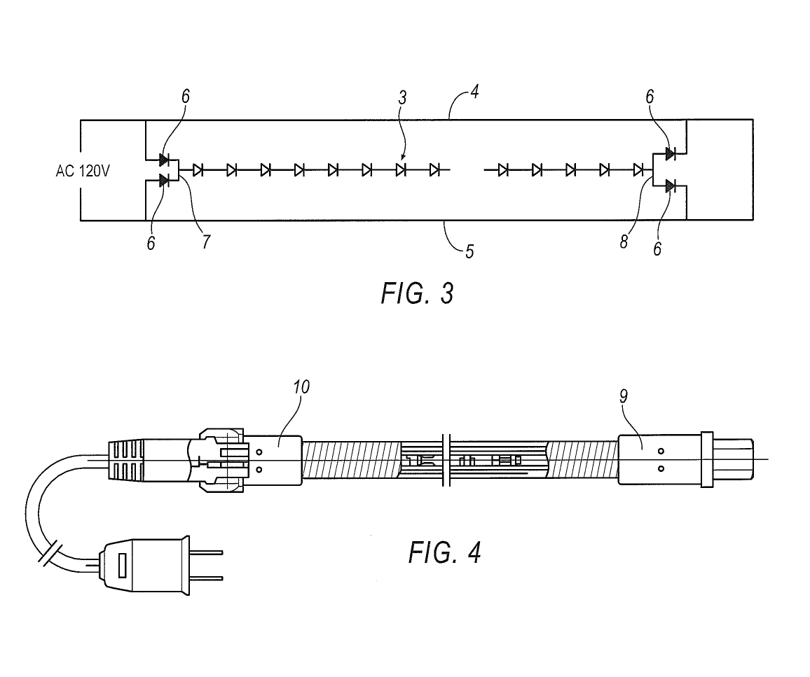

### TECHNICAL FIELD

This utility model involves a kind of rope light.

### BACKGROUND

The rope light is used for advertising decoration, commercial lighting, home lighting etc, and is very popular among the public at present. The rope light consists of an inner layer and an outer layer. LED lights are installed in the inner layer. In order to provide a direct current power supply to the LED lights, the structure of the current product is connecting an independent product, a rectifier, to one end of the inner layer and the outer layer. As such, the present product is suffering from the following defects: 1. the corresponding rectifiers have to be manufactured at the same time as the manufacturing of the rope lights, thereby increasing the manufacturing procedures and the production costs; 2. due to the fact that the rectifier is connected to the rope light in the exterior, the water-proof effect of the junction is not satisfactory; 3. due to the fact that the rectifier is connected to the rope light in the exterior, the structure of the rope light is not at all compact and the overall appearance is not very nice. In order to overcome the above defects, the inventor has designed this utility model.

### SUMMARY

This utility model overcomes the technical insufficiencies mentioned above and provides a kind of rope light with less manufacturing procedures, lower production costs, good water-proof effect, a compact structure and nice appearances.

In order to achieve the objectives mentioned above, this utility model adopts the following technical formula: a kind of rope light consisting of an inner layer and an outer layer covering the surface of the inner layer. There is a vertical hole in the interior of the mentioned inner layer. A number of LED lights are placed in the vertical hole. A bus connector with a positive electrode and a bus connector with a negative electrode are placed along the direction of the vertical hole in the walls of the inner layer. Two rectifying diodes are placed at the two ends of every LED lights inside the vertical hole. The positive electrode of one end of the two rectifying diodes is connected to the positive electrode of a bus connection and the negative electrode of a bus connector respectively. The negative electrode of the two rectifying diodes on this end is connected to form a positive direct current power supply, and then connect it with the positive electrode of the LED lights. The negative electrode of the other end of the two rectifying diodes is connected to the positive electrode of a bus connection and the negative electrode of a bus connector respectively. The positive electrode of the two rectifying diodes on this end is connected to form a negative direct current power supply, and then connect it with the negative electrode of the LED lights.

A male connector and a female connector have been installed at the two ends of the inner layer and the outer layer at the exterior of each of the LED lights.

The mentioned LED lights are made up of several series of LEDs.

The mentioned inner layer is made by the extrusion of thermoplastics by a mode extruder.

The beneficial effects of this utility model are:
1. Since the four rectifying diodes are installed inside the vertical hole of the inner layer, during the manufacturing process of the product, the four rectifying diodes are placed in the vertical hole at the same time as the LED lights after connecting the two. This makes the production of a rope light with rectifier much more convenient and avoids the need to connect the rectifier separately like the present products, and thus with the benefits of less manufacturing procedures, lower production costs, good water-proof effect, a compact structure and nice appearances.
2. The length of the rope light can be increased by connecting the male connector with the female connector of the different rope light.

### BRIEF DESCRIPTION OF THE DRAWINGS

Diagram 1 is the structural drawing of one LED lights unit in this utility model;

Diagram 2 is the partial enlargement of the area marked A in Diagram 1;

Diagram 3 is the circuit diagram of this utility model;

Diagram 4 is the diagram showing the connection of the plug with the utility model.

### DETAILED DESCRIPTION

The following combines diagrams with a more detailed description of the implementation methods of the utility model:

See Diagram 1-3. This utility model is a kind of rope light consisting of an inner layer (1) and an outer layer (2) covering the surface of the inner layer (1). The mentioned inner layer (1) is made by the extrusion of thermoplastics by a mode extruder. There is a vertical hole (11) in the interior of the mentioned inner layer (1). A number of LED lights (3) are placed in the vertical hole (11). A bus connector with a positive electrode (4) and a bus connector with a negative electrode (5) are placed along the direction of the vertical hole (11) in the walls of the inner layer (1). Two rectifying diodes (6) are placed at the two ends of every LED lights inside the vertical hole (11). The positive electrode of one end of the two rectifying diodes is connected to the positive electrode of a bus connection (4) and the negative electrode of a bus connector (5) respectively. The negative electrode of the two rectifying diodes on this end is connected to form a positive direct current power supply (7), and then connect it with the positive electrode of the LED lights (3). The negative electrode of the other end of the two rectifying diodes is connected to the positive electrode of a bus connection (4) and the negative electrode of a bus connector (5) respectively. The positive electrode of the two rectifying diodes on this end is connected to form a negative direct current power supply (8), and then connect it with the negative electrode of the LED lights (3). The mentioned four rectifying diodes form a rectifier and provide direct current power supply to the LED lights (3). Since the four rectifying diodes are installed inside the vertical hole (11) of the inner layer (1), during the manufacturing process of the product, the four rectifying diodes are placed in the vertical hole (11) at the same time as the LED lights (3) after connecting the two. This makes the production of a rope light with rectifier much more convenient and avoids the need to connect the rectifier separately like the present products. As such, this utility model possesses the advantages of less manufacturing procedures, lower production costs, good water-resistant effect, a compact structure and nice appearances.

Due to the different needs of the customers, they may require rope light of different lengths. In order to satisfy the needs of the customers to adjust the length of the rope light, this product is made up of a number of units. A male connector (9) and a female connector (10) have been installed at the two ends of the inner layer (1) and the outer layer (2) at the exterior of each of the LED lights (3). The length of the rope light can be increased by connecting the male connector (9) with the female connector (10) of several rope lights when needed. When the rope light is connected to a power source, it can be connected through connecting the female connector (10) with the plug of the male connector, and through connecting the plug and the power source, it provides alternating current power supply to this product. The alternating current power supply flowing through the four rectifying diodes forms the direct current power supply and provides electricity to the LED lights.

See Diagram 3. The mentioned LED lights (3) are mainly used for illuminating purpose. It is made up of several LEDs arranging in series. The positive electrode of the first LED is the positive electrode of the whole LED lights series (3). The negative electrode of the first LED is connected to the positive electrode of the second LED. The negative electrode of the second LED is connected to the positive electrode of the third LED. The series of LEDs are connected in this way. The negative electrode of the second last LED is connected to the positive electrode of the last LED. The negative electrode of the last LED is the negative electrode of the whole LED lights series (3). The positive electrode of the mentioned first LED is connected with positive electrode of the direct current power supply (7). The negative electrode of the mentioned last LED is connected with the negative electrode of the direct current power supply (8).

Of course, the mentioned LED lights (3) can be formed by connecting several LEDs in series or in other patterns.

1. A rope light comprising:
an inner layer having first and second ends;
an outer layer, wherein the outer layer covers an outer surface of the inner layer;
at least one aperture positioned in the interior of the inner layer;
at least one LED light positioned within the aperture;
at least one bus connector having at least one of a positive electrode and a negative electrode, wherein the bus connector is placed along the direction of the aperture; and
at least one rectifying diodes is placed at each positive and negative end of the LED light that is positioned inside the aperture, wherein the positive electrode of one end of the rectifying diode is connected to the positive electrode of a bus connection and the negative electrode of the bus connector and the negative electrode of the rectifying diode on an opposite of the bus connector end is connected to form a positive direct current power supply, which is connected to the positive electrode of the LED lights, wherein the negative electrode on an opposite end of the rectifying diode is connected to the positive electrode of the bus connection and the negative electrode of the bus connector respectively, and wherein the positive electrode of the rectifying diode on an opposite end is connected to form a negative direct current power supply, and then connect it with the negative electrode of the LED lights.

2. The rope light according to claim 1, further includes a a male connector and a female connector installed at each end of the inner layer and the outer layer at the exterior of each LED light.

3. The rope light according to claim 1, wherein the at least one LED lights is made up of several series of LEDs.

4. The rope light according to claim 1, wherein the inner layer is made by the extrusion of thermoplastics by a mode extruder.

5. The rope light according to claim 1, wherein the aperture is a vertical aperture positioned in the inner liner.
